(19) United States
(12) Patent Application Publication
(10) Pub. No.: US 2024/0159605 A1
(43) Pub. Date: May 16, 2024

(54) PRESSURE SENSOR

(71) Applicant: NITTA CORPORATION, Osaka-shi, Osaka (JP)

(72) Inventors: Kengo ISODA, Yamatokooriyama-shi (JP); Hisashi YAMAMOTO, Yamatokooriyama-shi (JP); Koji IWATA, Yamatokooriyama-shi (JP)

(73) Assignee: NITTA CORPORATION, Osaka-shi, Osaka (JP)

(21) Appl. No.: 18/281,984

(22) PCT Filed: Feb. 25, 2022
(86) PCT No.: PCT/JP2022/007875

§ 371 Date: Sep. 14, 2023

(30) Foreign Application Priority Data
Mar. 17, 2021 (JP) 2021-043131

(51) Int. Cl. G01L 1/20

(52) U.S. Cl. CPC G01L 1/205

(57) ABSTRACT

This pressure sensor is configured to detect pressure. The pressure sensor comprises a first sheet member and a second sheet member. The second sheet member is disposed so as to overlie the first sheet member. First and second electrodes are formed on the first sheet member. A third electrode which is covered by a pressure-sensitive electroconductive layer is formed on the second sheet member. When the pressure sensor is being used, a voltage is applied between the first and second electrodes. Regardless of whether the pressure sensor is being used, the first and second electrodes are each in contact with the pressure-sensitive electroconductive layer.

### TECHNICAL FIELD

The present invention relates to a pressure sensor, and in particular, to a pressure sensor configured to detect pressure.

### BACKGROUND ART

Japanese Patent Laid-open Publication No. 2016-024109 (Patent Document 1) discloses a pressure sensor.

### PRIOR ART DOCUMENT

### Patent Document

Patent Document 1: Japanese Patent Laid-open Publication No. 2001-159569

### SUMMARY OF THE INVENTION

### Problems to be Solved by the Invention

For example, in the pressure sensor as disclosed in Patent Document 1, the present inventors have found that there is a problem that an output value of the pressure sensor does not linearly change with respect to a change in a load applied to the pressure sensor.

The present invention has been made to solve such a problem, and an object thereof is to provide a pressure sensor in which an output value related to pressure more linearly changes with respect to the change in the load applied to the pressure sensor.

### Means for Solving the Problem

The pressure sensor according to the present invention is configured to detect pressure. The pressure sensor includes a first sheet member and a second sheet member. The second sheet member is disposed to overlie the first sheet member. First and second electrodes are formed on the first sheet member. A third electrode covered by the pressure-sensitive electroconductive layer is formed on the second sheet member. When the pressure sensor is being used, a voltage is applied between the first and second electrodes. Regardless of whether the pressure sensor is being used, the first and second electrodes are each in contact with the pressure-sensitive electroconductive layer.

It is assumed that, on the second sheet member, the third electrode is not formed and only the pressure-sensitive electroconductive layer is formed. In this case, when the pressure sensor is being used, a current flows from one of the first and second electrodes to the other mainly via the pressure-sensitive electroconductive layer. Since a current flows in a wide range of the pressure-sensitive electroconductive layer, a volume resistance value caused by the pressure-sensitive electroconductive layer increases. The present inventors have found that the larger the volume resistance value caused by the pressure-sensitive electroconductive layer is, the more the linearity of the pressure sensor is adversely affected. Note that the linearity of the pressure sensor refers to a degree of linearity of the change in the output value of the pressure sensor with respect to the change in the load applied to the pressure sensor. Here, the output value of the pressure sensor is obtained by converting a resistance value output indicated by a hyperbola into a voltage value output passing through the origin, for example, by using an operational amplifier.

In the pressure sensor according to the present invention, in the second sheet member, the pressure-sensitive electroconductive layer covers the third electrode. Therefore, in the pressure sensor, when the pressure sensor is being used, a current flows from one of the first and second electrodes to the other via the pressure-sensitive electroconductive layer and the third electrode. In this case, as compared with a case where the third electrode is not formed on the second sheet member, since a current flows in a narrow range of the pressure-sensitive electroconductive layer, the volume resistance value caused by the pressure-sensitive electroconductive layer decreases. Therefore, according to this pressure sensor, since the volume resistance value caused by the pressure-sensitive electroconductive layer decreases, the linearity of the pressure sensor can be improved.

In the above-described pressure sensor, the third electrode may be made of the same material as the first and second electrodes.

In the above-described pressure sensor, L1/T1 may be larger than 40, where L1 is a distance between the first and second electrodes and T1 is a thickness of the pressure-sensitive electroconductive layer.

In the above-described pressure sensor, the first and second electrodes may each include a portion having a comb-teeth shape.

### Advantages of the Invention

According to the present invention, it is possible to provide a pressure sensor in which an output value related to pressure more linearly changes with respect to a change in a load applied to the pressure sensor.

### BRIEF DESCRIPTION OF THE DRAWINGS

FIG. 1 is a view schematically illustrating a part of a plane of a pressure sensor.

FIG. 2 is a view schematically illustrating a cross section taking along II-II in

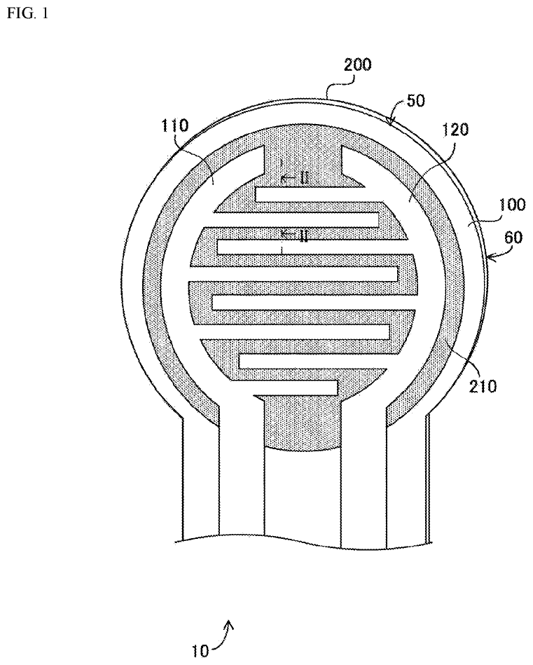

FIG. 1.

FIG. 3 is a view schematically illustrating a part of a cross section of a pressure sensor to be compared.

FIG. 4 is a view schematically illustrating a part of a cross section of a pressure sensor.

FIG. 5 is a graph illustrating linearity of a pressure sensor to be compared.

FIG. 6 is a graph illustrating linearity of a pressure sensor according to an embodiment.

FIG. 7 is a view schematically illustrating planes of a first electrode, a second electrode, and a pressure-sensitive electroconductive layer included in a pressure sensor according to a variation.

### EMBODIMENT OF THE INVENTION

Hereinafter, an embodiment of the present invention will be described in detail with reference to the drawings. Note that in the drawings, the same or corresponding parts are denoted by the same reference numerals, and the description thereof will not be repeated.

[1. Configuration of Pressure Sensor]

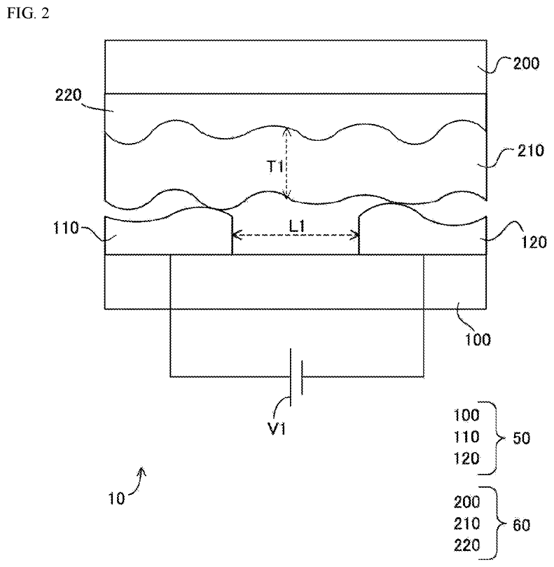

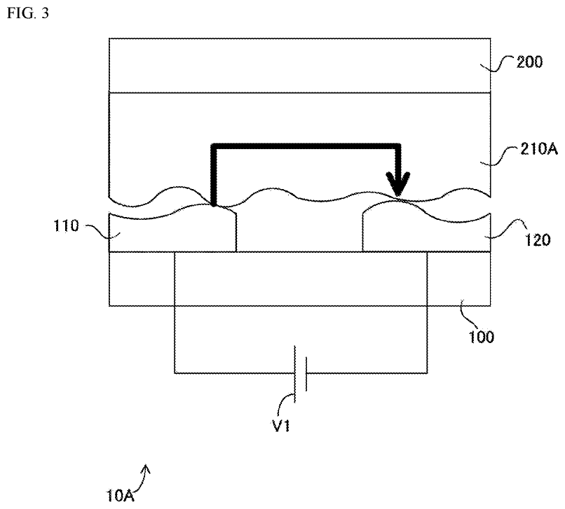

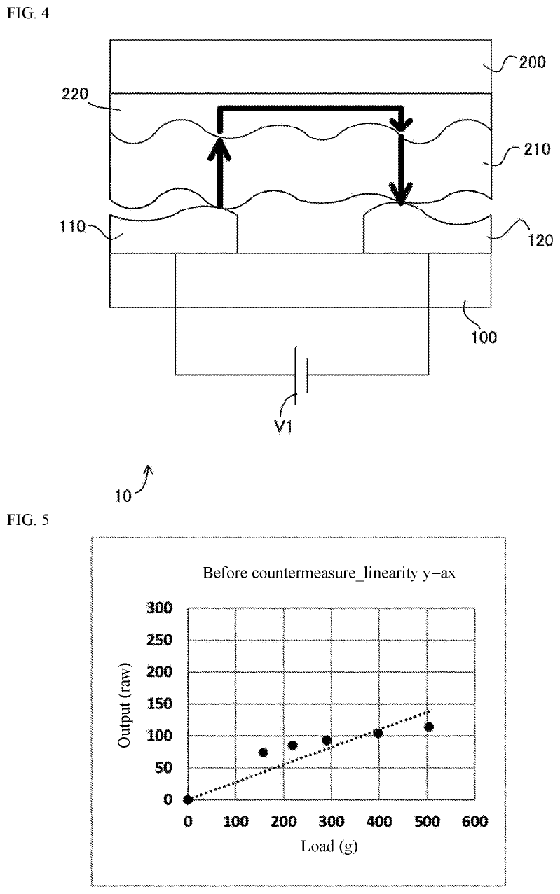

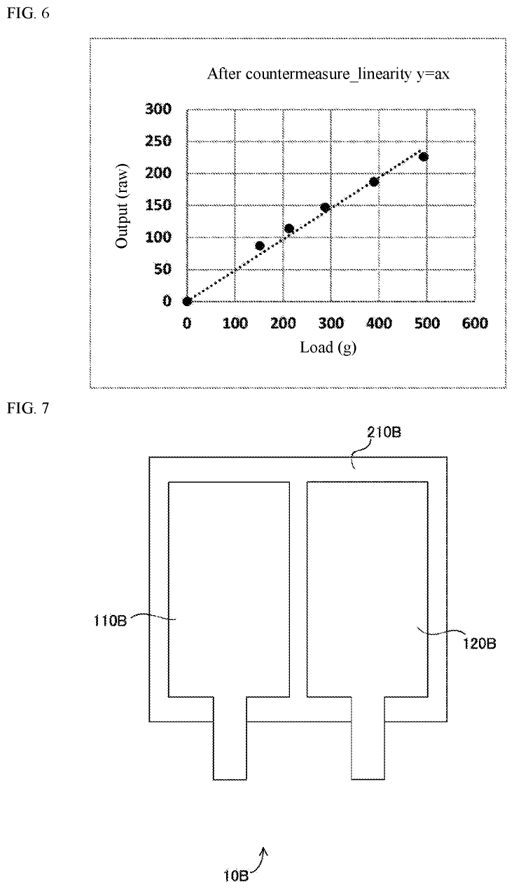

FIG. 1 is a view schematically illustrating a part of a plane of a pressure sensor 10 according to the present embodiment. FIG. 2 is a view schematically illustrating a cross section taking along II-II in FIG. 1.

Referring to FIGS. 1 and 2, the pressure sensor 10 is configured to detect an applied pressure. The pressure sensor 10 includes a first sheet member 50 and a second sheet member 60. In the pressure sensor 10, the first sheet member 50 and the second sheet member 60 overlie each other. The first sheet member 50 and the second sheet member 60 each includes a portion having a substantially circular shape and a portion having a rectangular shape in plan view. The first sheet member 50 and the second sheet member 60 are not bonded to each other in the portions, respectively, each having the substantially circular shape. In the pressure sensor 10, a pressure for pinching the first sheet member 50 and the second sheet member 60 is detected.

The first sheet member 50 includes a base material 100, a first electrode 110, and a second electrode 120. The base material 100 is a member having a sheet shape, and includes a portion having a substantially circular shape and a portion having a rectangular shape. The base material 100 is made of a flexible material such as polyimide or polyethylene terephthalate (PET).

The first electrode 110 and the second electrode 120 are each formed on the base material 100. The first electrode 110 and the second electrode 120 each includes a portion having a comb-teeth shape and a portion having a rectangular shape in plan view. The first electrode 110 and the second electrode 120 are disposed such that each one of the comb-teeth of the first electrode 110 and a respective one of the comb-teeth of the second electrode 120 are alternately located. The first electrode 110 and the second electrode 120 are each made of, for example, a metal foil such as a silver foil, a copper foil, or an aluminum foil, or an electroconductive polymer. Note that the materials of the first electrode 110 and the second electrode 120 are not limited thereto, and any material may be used as long as the material has high electroconductivity.

The second sheet member 60 includes a base material 200, a third electrode 220, and a pressure-sensitive electroconductive layer 210. The base material 200 is a member having a sheet shape and has substantially the same shape as the base material 100. Similarly to the base material 100, the base material 200 is made of a flexible material such as polyimide or PET.

The third electrode 220 is formed on the base material 200. The shape of the third electrode 220 is a substantially circular shape in plan view. Similarly to the first electrode 110 and the second electrode 120, the third electrode 220 is made of, for example, a metal foil such as a silver foil, a copper foil, or an aluminum foil, or an electroconductive polymer. Note that the material of the third electrode 220 is not limited thereto, and any material may be used as long as the material has high electroconductivity. Note that in the present embodiment, the third electrode 220 is made of the same material as the first electrode 110 and the second electrode 120.

In the second sheet member 60, the pressure-sensitive electroconductive layer 210 is formed to cover the third electrode 220. The shape of the pressure-sensitive electroconductive layer 210 is a substantially circular shape slightly larger than the third electrode 220 in plan view. The pressure-sensitive electroconductive layer 210 is formed of a pressure-sensitive electroconductive ink. As the pressure-sensitive electroconductive ink, a known pressure-sensitive electroconductive ink containing electroconductive particles may be used.

Examples of the electroconductive particles contained in the pressure-sensitive electroconductive ink include carbon-based particles (including fibrous materials) such as carbon black, graphite, carbon nanotube, carbon nanohorn, carbon nanofiber, and carbon nanocoil; metal particles such as iron, nickel, copper, aluminum, magnesium, platinum, silver, gold, and an alloy containing at least one of these metals; and conductive inorganic material particles such as tin oxide, zinc oxide, silver iodide, copper iodide, barium titanate, indium tin oxide, and strontium titanate. The electroconductive particles may be used in one type thereof alone or in combination of two or more types thereof.

In the pressure sensor 10, L1/T1 is larger than 40, where L1 is a distance between the first electrode 110 and second electrode 120 and T1 is a thickness of the pressure-sensitive electroconductive layer 210. In addition, 1/T1 may be larger than 50. That is, in the pressure sensor 10, the distance L1 between the first electrode 110 and the second electrode 120 is much longer than the thickness T1 of the pressure-sensitive electroconductive layer 210.

In the pressure sensor 10, a member that separates the first sheet member 50 and the second sheet member 60 is not particularly provided. Therefore, in the pressure sensor 10, regardless of whether the pressure sensor 10 is being used, the first electrode 110 and the second electrode 120 are each in contact with the pressure-sensitive electroconductive layer 210.

When the pressure sensor 10 is being used, a voltage is applied between the first electrode 110 and the second electrode 120. For example, a positive electrode of a power supply V1 is connected to the first electrode 110, and a negative electrode of the power supply V1 is connected to the second electrode 120. In this case, the first electrode 110 and the second electrode 120 are in a state of being electrically connected to each other via the pressure-sensitive electroconductive layer 210 and the third electrode 220. When the pressure applied to the pressure sensor 10 increases, the contact area between each of the first electrode 110 and the second electrode 120 and the pressure-sensitive electroconductive layer 210 increases. As a result, the resistance value between the first electrode 110 and the second electrode 120 decreases, and the current value generated between the first electrode 110 and the second electrode 120 increases. By detecting the change in the current value, the pressure applied to the pressure sensor 10 is detected.

[2. Reason why Third Electrode is Provided on Second Sheet Member]

As described above, in the pressure sensor 10, the pressure-sensitive electroconductive layer 210 covers the third electrode 220. The reason for this will be described next. Generally, in a pressure sensor, an output value related to pressure is required to more linearly change with respect to the change in the load applied to the pressure sensor. Here, the output value related to the pressure is obtained by converting a resistance value output indicated by a hyperbola into a voltage value output passing through the origin, for example, by using an operational amplifier.

FIG. 3 is a view schematically illustrating a part of a cross section of a pressure sensor 10A to be compared. As illustrated in FIG. 3, in the pressure sensor 10A, the third electrode 220 is not formed on the base material 200. On the base material 200, only a pressure-sensitive electroconductive layer 210A is formed.

When pressure is applied to the pressure sensor 10A in a state where a voltage is applied between the first electrode 110 and the second electrode 120, a current is generated between the first electrode 110 and the second electrode 120 via the pressure-sensitive electroconductive layer 210A. That is, a current flows in a wide range of the pressure-sensitive electroconductive layer 210A. As a result, a ratio occupied by a volume resistance component caused by the pressure-sensitive electroconductive layer 210A in the resistance components between the first electrode 110 and the second electrode 120 increases.

When pressure is applied to the pressure sensor 10A, the resistance component caused by the contact area between each of the first electrode 110 and the second electrode 120 and the pressure-sensitive electroconductive layer 210A greatly changes. On the other hand, when pressure is applied to the pressure sensor 10A, the volume resistance component caused by the pressure-sensitive electroconductive layer 210A hardly changes. That is, the volume resistance component caused by the pressure-sensitive electroconductive layer 210A exists as an offset with respect to the total resistance component between the first electrode 110 and the second electrode 120. Since the pressure sensor 10A detects the pressure based on the change in the resistance value between the first electrode 110 and the second electrode 120, when the offset value (volume resistance component caused by the pressure-sensitive electroconductive layer 210A) increases, the linearity of the pressure sensor 10A decreases. That is, the present inventors have found that the larger the volume resistance value caused by the pressure-sensitive electroconductive layer 210A is, the more the linearity of the pressure sensor 10A is adversely affected.

FIG. 4 is a view schematically illustrating a part of a cross section of the pressure sensor 10 according to the present embodiment. As illustrated in FIG. 4, in the pressure sensor 10, the pressure-sensitive electroconductive layer 210 covers the third electrode 220. The resistance value of the third electrode 220 is much lower than the resistance value of the pressure-sensitive electroconductive layer 210. Therefore, when pressure is applied to the pressure sensor 10, a current flows between the first electrode 110 and the second electrode 120 via the pressure-sensitive electroconductive layer 210 and the third electrode 220.

In particular, in the pressure-sensitive electroconductive layer 210, a current mainly flows in the thickness direction of the pressure-sensitive electroconductive layer 210. Since the length of the pressure-sensitive electroconductive layer 210 in the thickness direction is much shorter than the length between the first electrode 110 and the second electrode 120, the range in which the current flows in the pressure-sensitive electroconductive layer 210 is narrower than that in the example illustrated in FIG. 3. Therefore, the volume resistance value caused by the pressure-sensitive electroconductive layer 210 decreases between the first electrode 110 and the second electrode 120. As a result, according to the pressure sensor 10, since the volume resistance value caused by the pressure-sensitive electroconductive layer 210 decreases, the linearity of the pressure sensor 10 can be improved.

FIG. 5 is a graph illustrating linearity of the pressure sensor 10A to be compared. FIG. 6 is a graph illustrating linearity of the pressure sensor 10 according to the present embodiment. In each of FIGS. 5 and 6, the horizontal axis represents the load applied to the pressure sensor, and the vertical axis represents the output of the pressure sensor. Referring to FIGS. 5 and 6, it can be seen that the pressure sensor 10 has higher linearity than the pressure sensor 10A.

In general, in a pressure sensor of a comb-teeth type, in order to improve linearity, it is necessary to increase the length of each comb-teeth of a respective one of electrodes and to shorten the distance between the comb-teeth adjacent to each other. However, by forming the third electrode 220 on the second sheet member 60, the linearity of the pressure sensor does not significantly decrease, even if the distance between the comb-teeth increases, for example. Therefore, according to the pressure sensor 10, since fine processing is not required in manufacturing process, productivity can be improved.

[3. Features]

As described above, in the pressure sensor 10 according to the present embodiment, in the second sheet member 60, the pressure-sensitive electroconductive layer 210 covers the third electrode 220. Therefore, in the pressure sensor 10, when the pressure sensor 10 is being used, a current flows from one of the first electrode 110 and the second electrode 120 to the other via the pressure-sensitive electroconductive layer 210 and the third electrode 220. In this case, as compared with a case where the third electrode 220 is not formed on the second sheet member 60, since a current flows in a narrow range of the pressure-sensitive electroconductive layer 210, the volume resistance value caused by the pressure-sensitive electroconductive layer 210 decreases. Therefore, according to the pressure sensor 10, since the volume resistance value caused by the pressure-sensitive electroconductive layer 210 decreases, the linearity of the pressure sensor 10 can be improved.

[4. Variation]

Although the embodiment has been described above, the present invention is not limited to the above-described embodiment, and various modifications can be made without departing from the gist thereof. Hereinafter, a variation will be described.

<4-1>

As described above, by forming the third electrode 220 on the second sheet member 60, the linearity of the pressure sensor does not significantly decrease, even if the distance between the comb-teeth increases, for example. In the first place, each electrode does not need to be the comb-teeth type.

FIG. 7 is a view schematically illustrating planes of a first electrode 110B, a second electrode 120B, and a pressure-sensitive electroconductive layer 210B included in a pressure sensor according to a variation. As long as the third electrode 220 is formed on the second sheet member 60, each of the shapes of the first electrode 110B, the second electrode 120B, and the pressure-sensitive electroconductive layer 210B may be, for example, a respective one of shapes as illustrated in FIG. 7. That is, the areas of the first electrode and the second electrode can be made larger than those of the pressure sensor 10 according to the above embodiment. The pressure-sensitive electroconductive layer has minute unevenness. The unevenness and a distribution of electroconductive materials affect output accuracy of the pressure sensor. As the contact area between each electrode and the pressure-sensitive electroconductive layer increases, the unevenness and the distribution of the electroconductive materials are averaged, and the resistance value at the time of pressurization is stabilized. As a result, the output accuracy of the pressure sensor 10B is stabilized, and the repeatability is improved.

<4-2>

In the above embodiment, the first electrode 110 was connected to the positive electrode of the power supply V1, and the second electrode 120 was connected to the negative electrode of the power supply V1. However, the connection relationship between the power supply V1 and each electrode is not limited thereto. For example, the first electrode 110 may be connected to the negative electrode of the power supply V1, and the second electrode 120 may be connected to the positive electrode of the power supply V1.

<4-3>

In the above embodiment, the shape of each of the pressure-sensitive electroconductive layer 210 and the third electrode 220 was substantially circular shape in plan view. However, the shape of each of the pressure-sensitive electroconductive layer 210 and the third electrode 220 is not necessarily substantially circular shape. For example, the shape of each of the pressure-sensitive electroconductive layer 210 and the third electrode 220 may be a rectangular shape.

<4-4>

In the above embodiment, the first electrode 110, the second electrode 120, and the third electrode 220 were each made of the same material. However, the first electrode 110, the second electrode 120, and the third electrode 220 may not necessarily be each made of the same material. The first electrode 110, the second electrode 120, and the third electrode 220 may be each made of different materials, for example.

<4-5>

In the above embodiment, L1/T1 was larger than 40, where L1 was a distance between the first electrode 110 and second electrode 120 and T1 was a thickness of the pressure-sensitive electroconductive layer 210. However, L1/T1 may be less than 40. At least, the distance L1 between the first electrode 110 and the second electrode 120 may be longer than the thickness T1 of the pressure-sensitive electroconductive layer 210.

### DESCRIPTION OF REFERENCE SIGNS

10, 10A, 10B: Pressure sensor
50: First sheet member
60: Second sheet member
100, 200: Base material
110, 110B: First electrode
120, 120B: Second electrode
210, 210A, 210B: Pressure-sensitive electroconductive layer
220: Third electrode
V1: Power supply

1. A pressure sensor configured to detect pressure, the pressure sensor comprising:
a first sheet member; and
a second sheet member disposed to overlie the first sheet member,
wherein first and second electrodes are formed on the first sheet member,
a third electrode covered by a pressure-sensitive electroconductive layer is formed on the second sheet member,
when the pressure sensor is being used, a voltage is applied between the first and second electrodes, and
regardless of whether the pressure sensor is being used, the first and second electrodes are each in contact with the pressure-sensitive electroconductive layer.

2. The pressure sensor according to claim 1, wherein the third electrode is made of the same material as the first and second electrodes.

3. The pressure sensor according to claim 1, wherein L1/T1 is larger than 40, where L1 is a distance between the first and second electrodes and T1 is a thickness of the pressure-sensitive electroconductive layer.

4. The pressure sensor according to claim 1, wherein the first and second electrodes each includes a portion having a comb-teeth shape.

5. The pressure sensor according to claim 2, wherein the first and second electrodes each includes a portion having a comb-teeth shape.

6. The pressure sensor according to claim 3, wherein the first and second electrodes each includes a portion having a comb-teeth shape.
